(19) United States
(12) Patent Application Publication
(10) Pub. No.: US 2012/0298542 A1
(43) Pub. Date: Nov. 29, 2012

(54) SELF-ERASING MEMORANDUM SYSTEM

(76) Inventor: Michael Littlejohn, Norton, OH (US)

(21) Appl. No.: 13/476,139

(22) Filed: May 21, 2012

Related U.S. Application Data
(60) Provisional application No. 61/488,857, filed on May 23, 2011.

(51) Int. Cl. B43L 1/12; B65D 85/00

(52) U.S. Cl. 206/459.5; 434/410

(57) ABSTRACT

Some embodiments of the invention may relate to a container and/or a self-erasing memorandum system. Embodiments may include a low-tack adhesive layer adapted to be adhered to a substrate and a polymer film adapted to contact and substantially cover the low-tack adhesive layer. According to some embodiments the polymer film may be adapted to reversibly adhere to the low-tack adhesive layer while maintaining a translucent layer of air therebetween. Furthermore, the polymer film and low-tack adhesive layer may be adapted to displace at least a portion of the translucent air layer in response to pressure applied to selected portions of the polymer film.

This application claims priority to U.S. Provisional Patent Application No. 61/488,857 filed May 23, 2011 and now pending which is incorporated herein by reference in its entirety.

### I. BACKGROUND OF THE INVENTION

A. Field of Invention

Some embodiments may generally relate to devices and/or methods for an erasable means of creating visually perceptible indicia.

B. Description of the Related Art

It is well known that food and beverage containers may be lost or easily misplaced when used in a public environment where numerous people may be using similar containers. For instance, many attendees of a sporting event may purchase the same brand of bottled water and may easily lose track of their bottle when it is placed in a common area where others have placed similar bottles. Thus, it is desirable to label one's bottle in some way to distinguish it from others. One well known way to accomplish this is to write one's name on the container either directly or on a label. However, writing implements may not always be available, and it may not be desirable to place a permanent label on each container.

What is needed is an erasable means for labeling containers which may be reused many times. Some embodiments of the present invention may provide one or more benefits or advantages over the prior art.

### II. SUMMARY OF THE INVENTION

Some embodiments may relate to a self-erasing memorandum system, comprising: a low-tack adhesive layer adapted to be adhered to a substrate, the low-tack adhesive layer defining a predetermined two-dimensional shape and area; and a polymer film adapted to contact and substantially cover the low-tack adhesive layer, wherein the polymer film is adapted to reversibly adhere to the low-tack adhesive layer while maintaining a translucent layer of air therebetween, wherein the polymer film and low-tack adhesive layer are adapted to displace at least a portion of the translucent air layer in response to pressure applied to selected portions of the polymer film.

According to some embodiments the low-tack adhesive layer comprises a reusable low-tack pressure sensitive composition.

According to some embodiments the low-tack adhesive layer defines a thickness between about 0.01 to about 0.1 mils, 0.1 to 0.5 mils, 0.5 to 1 mils, 1 to 5 mils, 5 to 10 mils, 10 to 50 mils, 50 to 100 mils, or any combination thereof.

According to some embodiments the substrate comprises ceramic, glass, metal, or plastic.

According to some embodiments the substrate comprises one or more of a container, a food container, a beverage container, container labeling, or container packaging.

According to some embodiments the polymer film is colorless, pigmented, translucent, transparent, partially transparent, or any combination thereof.

According to some embodiments the polymer film comprises one or more of polycarbonate, polymethylmethacrylate, acrylic polymer, polyester, cellulose, cellophane, polyolefin, polyethylene, polypropylene, polyethyleneterephthalate, polyvinyl chloride, or any combination thereof.

According to some embodiments the polymer film defines a thickness from about 0.1 to 0.5 mils, 0.5 to 1 mils, 1 to 5 mils, 5 to 10 mils, 10 to 50 mils, or even 50 to 100 mils.

According to some embodiments the polymer film is adapted to be permanently affixed to the substrate at one edge of the polymer film forming a flap adapted to adhere to and be separated from the adhesive layer while remaining attached to the substrate.

According to some embodiments the substrate comprises a free-standing monolithic structure which defines a substrate sheet, and which is adapted to be adhesively affixed to a second substrate.

According to some embodiments the substrate sheet supports the low-tack adhesive layer on one face of the substrate sheet, and the substrate sheet supports a second adhesive layer on a second face of the substrate sheet.

Some embodiments may relate to a self-erasing memorandum system, comprising: a substrate sheet having a first face and a second face generally opposing the first face; a low-tack adhesive layer disposed on the first face of the substrate sheet, the low-tack adhesive layer defining a predetermined two-dimensional shape and area; a second adhesive layer disposed on the second face of the substrate sheet; and a polymer film adapted to contact and substantially cover the low-tack adhesive layer, wherein the polymer film is adapted to reversibly adhere to the low-tack adhesive layer while maintaining a translucent layer of air bubbles therebetween, wherein the polymer film and low-tack adhesive layer are adapted to displace at least a portion of the translucent air bubble layer in response to pressure applied to selected portions of the polymer film.

Some embodiments may relate to a container, comprising: a wall structure at least partially inclosing a space for containing an arbitrary substance, the wall structure having and inner surface and an outer surface, wherein the outer surface defines a substrate; a low-tack adhesive layer disposed on and at least partially covering the substrate, the adhesive layer defining a predetermined two-dimensional shape and area; and a polymer film adapted to contact and substantially cover the low-tack adhesive layer, wherein the polymer film is adapted to reversibly adhere to the low-tack adhesive layer while maintaining a translucent layer of air bubbles therebetween, wherein the polymer film and low-tack adhesive layer are adapted to displace at least a portion of the translucent air bubble layer in response to pressure applied to selected portions of the polymer film.

According to some embodiments the polymer film is permanently affixed to the substrate at one edge of the polymer film forming a flap adapted to adhere to and be separated from the adhesive layer while remaining attached to the substrate.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a side view of an embodiment;

FIG. 2 is a magnified view of the area shown as 140 in FIG. 1;

FIG. 3 is a perspective view of an embodiment mounted on a substrate with one corner of the embodiment turned upward;

FIG. 4 is a perspective view of an embodiment mounted on a beverage container;

FIG. 5 is a side view of an embodiment having a substrate sheet layer; and

FIG. 6 is a perspective view of the embodiment of FIG. 5 shown in a free-standing and unmounted configuration.

### IV. DETAILED DESCRIPTION OF THE INVENTION

Embodiments of the invention may comprise an erasable memorandum system, and may include a low-tack adhesive layer adapted to reversibly mate with a free-standing polymer film in an adhesive relation. The low-tack adhesive layer may comprise a reusable low-tack adhesive. Placing the free-standing polymer film in contact with the low-tack adhesive layer may entrap an air layer between the polymer film and the low-tack adhesive layer. The air layer may scatter visible light so as to form a cloudy or translucent layer. Air may be expelled from between the polymer film and the low-tack adhesive layer by applying pressure to the polymer film. Thus, written matter may be formed by selectively applying pressure to portions of the polymer film using, for example, a stylus or similar implement or, in some embodiments, even a fingernail. The written matter may be erased by lifting the polymer film off of the low-tack adhesive layer.

Suitable adhesives according to embodiments of the invention can include reusable low tack pressure sensitive adhesives which retain their tack over long time scales such as months or years. In some embodiments, a suitable low tack adhesive resists flowing when exposed to temperatures up to about 100° C. or higher. In some embodiments, a suitable low tack adhesive remains flexible and/or tacky at temperatures as low as about 0° C. or lower and may resist cracking and/or flaking at such temperatures. Suitable materials comprising a low-tack adhesive according to some embodiments of the invention may include, without limitation, one or more of acrylic polymers, butyl rubber polymer, ethylene-vinyl acetate polymer, natural rubber, nitrile polymer, silicone rubber polymer, styrene block copolymers, styrene-butadiene-styrene, styrene-ethylene/butylene-styrene, styrene-ethylene/propylene, styrene-isoprene-styrene, vinyl ethers, or any combination thereof.

According to some embodiments, a suitable thicknesses of the low-tack adhesive layer may range from about 0.01 to 100 mils; however, one skilled in the art will appreciate that the appropriate thickness will depend on the physical mechanical properties of the particular material selected. Other suitable thicknesses can include about 0.01 to about 0.1 mils, 0.1 to 0.5 mils, 0.5 to 1 mils, 1 to 5 mils, 5 to 10 mils, 10 to 50 mils, or even 50 to 100 mils. Still other suitable ranges may be from about 0.1 to 0.2 mils, 0.2 to 0.3 mils, 0.3 to 0.4 mils, 0.4 to 0.5 mils, 0.5 to 0.6 mils, 0.6 to 0.7 mils, 0.7 to 0.8 mils, 0.8 to 0.9 mils, or 0.9 to 1 mils. Here as elsewhere in the specification and claims, ranges may be combined.

Free standing polymer films can comprise transparent, partially transparent, or translucent materials and can be made from materials which impart flexibility and low adhesion to the low-tack adhesive layer. According to some embodiments, polymer films may include pigmentation which may be applied in any of a wide variety of known way including, without limitation, through incorporation into the bulk polymer matrix, surface coating, laminating, painting, and/or printing. Thus, pigmented polymer films may be either transparent, translucent, or may have any degree of clarity between these two extremes. Suitable polymer films can comprise, without limitation, polycarbonate, polymethylmethacrylate, acrylic polymer, polyester, cellulose, cellophane, polyolefin, polyethylene, polypropylene, polyethyleneterephthalate, polyvinyl chloride, or any of a wide variety of polymer materials known in the art, or any combination thereof. Furthermore, suitable thicknesses of such materials may range from about 0.1 to 100 mils; however, one skilled in the art will appreciate that the appropriate thickness will depend on the particular material selected and its stiffness. Other suitable thicknesses can include about 0.1 to 0.5 mils, 0.5 to 1 mils, 1 to 5 mils, 5 to 10 mils, 10 to 50 mils, or even 50 to 100 mils. Still other suitable ranges may be from about 0.5 to 1 mils, 1 to 2 mils, 2 to 3 mils, 3 to 4 mils, 4 to 5 mils, 5 to 6 mils, 6 to 7 mils, 7 to 8 mils, 8 to 9 mils, or 9 to 10 mils.

In some embodiments a substrate supporting the adhesive layer can comprise a portion of a bottle, beverage container, food container, or any arbitrary container or item which a user wishes to mark. According to some embodiments, a substrate supporting the low tack adhesive layer may comprise packaging or labeling such as that of a container. Thus, substrates may vary widely in composition and may include, without limitation, ceramics, glasses, plastics, metals or even wood or paper. For instance, according to some embodiments, a plastic bottle or the label or packaging thereof may include a low-tack adhesive layer on a predetermined portion of its outer surface. The embodiment may include a free-standing polymer film, which may be permanently attached to the substrate at one edge of the film; however, in some embodiments the polymer film may not have a permanently attached edge and may therefore be completely removed from the substrate. In embodiment where the polymer film includes a permanently attached edge, the edge may be attached by means known in the art including, without limitation, welding, heat-driven fusion, polymer cements or glues, high-tack adhesion, or any other suitable means.

In some embodiments, the low-tack adhesive layer may be placed on a face of a substrate sheet, which has a second adhesive layer on the opposing face of the substrate sheet. Such an embodiment, may further include an integral polymer film attached to the substrate at an edge of the film and/or the substrate sheet. Accordingly, the substrate sheet may be placed on a surface selected by the user. For instance, a user may place the substrate sheet on a water or soda bottle of the user's choice and thus may be able to reversibly mark the bottle. In some embodiments the second adhesive layer may be high-tack or low-tack. In other embodiments the second adhesive may be water or solvent activated rather than pressure sensitive, and may be more or less permanently affixed to a substrate.

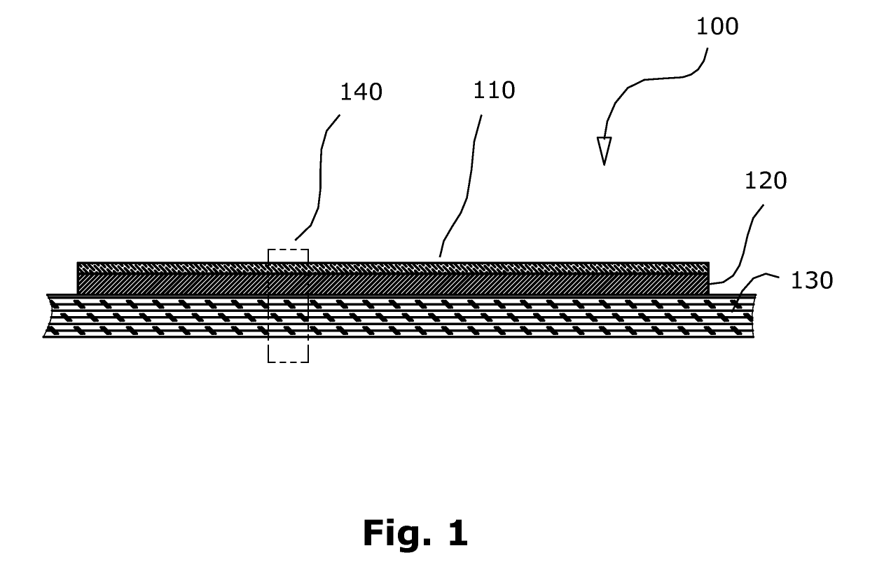

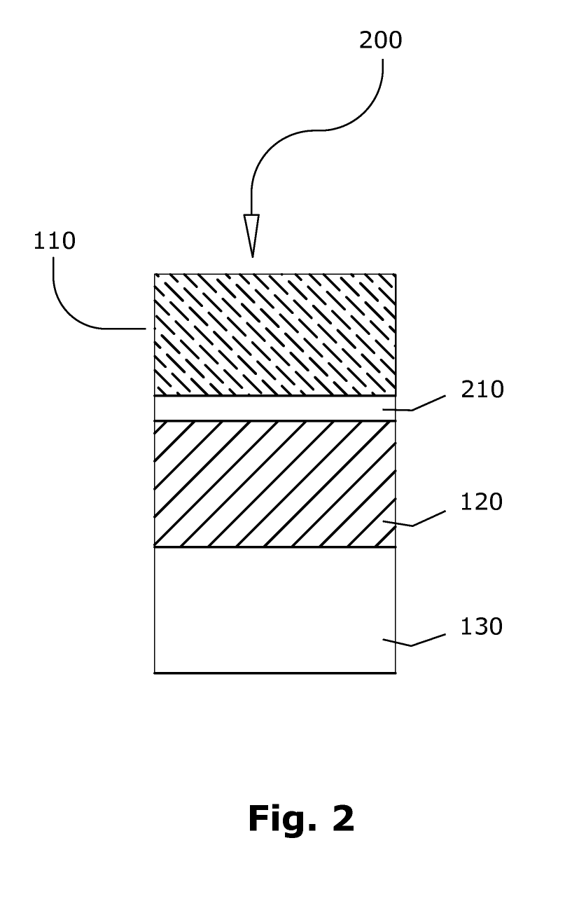

Referring now to the drawings wherein the showings are for purposes of illustrating embodiments of the invention only and not for purposes of limiting the same, FIG. 1 is a side view of an embodiment 100 having a low-tack adhesive layer 120. A translucent polymer film 110 is shown overlaying the low-tack adhesive layer 120. The embodiment 100 is shown mounted on an arbitrary substrate 130. Reference number 140 of FIG. 1 denotes an area of the embodiment 100 which is shown in magnification in FIG. 2. According to FIG. 2, a layer of air 210 is situated between the low-tack adhesive layer 120 and the polymer film 110. The layer of air 210 may be continuous or it may comprise air pockets or bubbles. The presence of an air layer 210 scatters incident visible light resulting in a foggy appearance. Expulsion of air from selected portions of the embodiment 100 result in visually perceptible contrasting areas of the embodiment which may form written indicia, for instance.

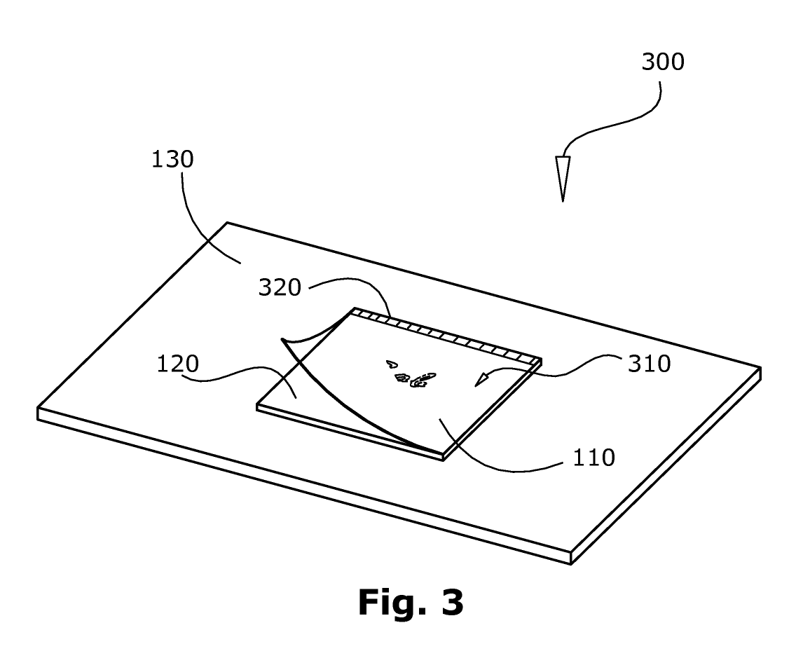

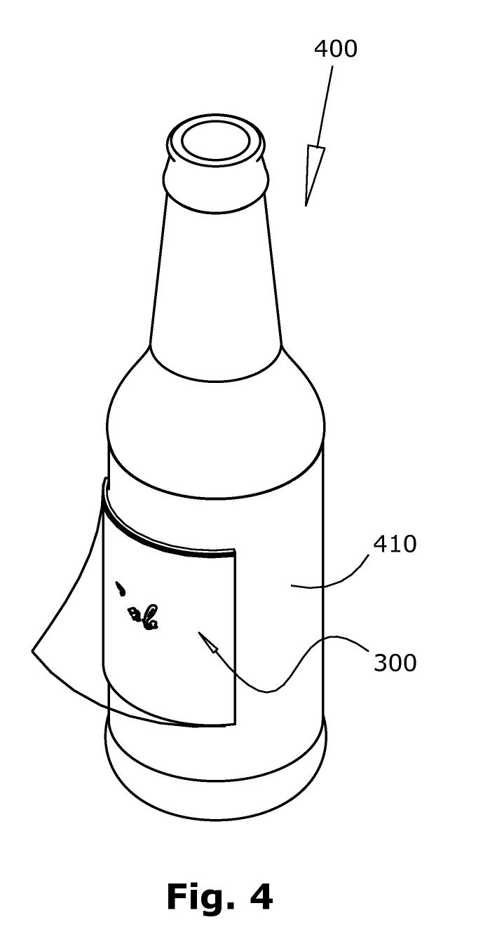

FIG. 3 is a perspective view of an embodiment 300 with one corner of the polymer film 110 upturned to reveal the underlying low-tack adhesive layer 120. Written indicia 310 is shown from above the embodiment 300, and the written indicia 310 is being erased by upturning the corner of the polymer film 110. The entire written indicia 310 may be erased by further lifting the polymer film 110 away from the low-tack adhesive layer 120. The embodiment 300 further comprises an attached edge 320 which is permanently affixed to the substrate 130. Accordingly, the polymer film 110 forms a flap which may be pulled away from the low-tack adhesive layer 120 but not detached from the substrate 130. FIG. 4 shows the embodiment 300 installed 400 on a bottle 410.

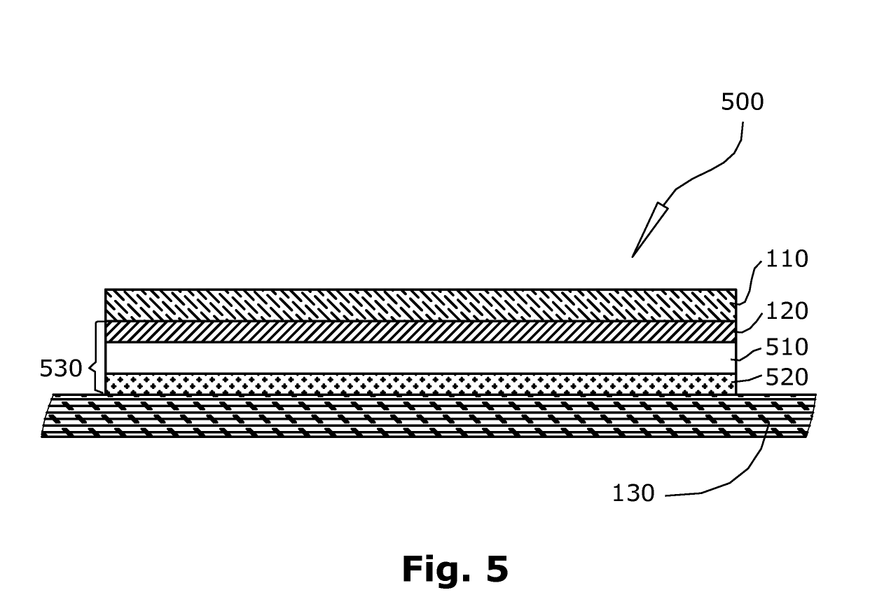

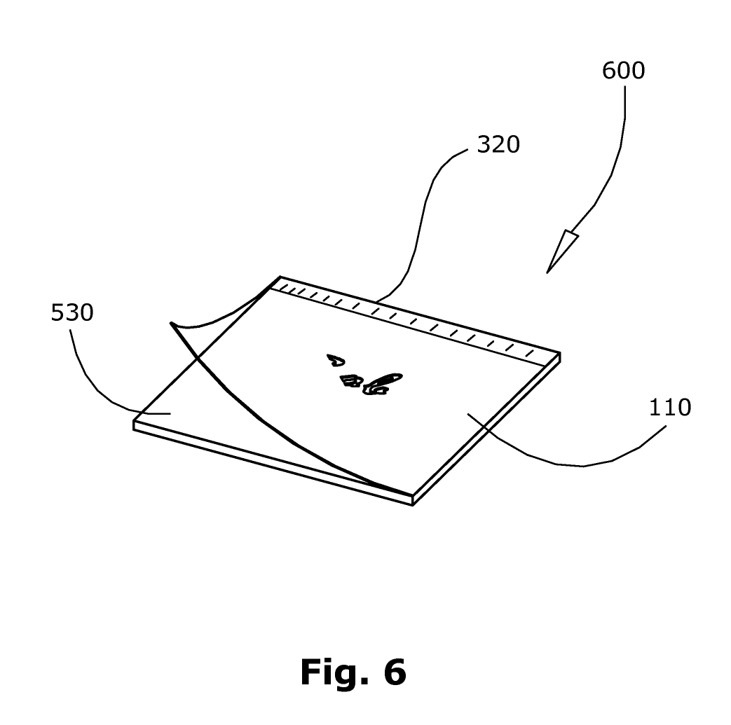

FIG. 5 is a side view of an embodiment 500 having a substrate sheet layer 510. The substrate sheet layer 510 supports a low-tack adhesive layer 120 on one face of the sheet layer 510 and a second adhesive layer 520 on the other face of the sheet layer 510. FIG. 5 illustrates the embodiment 500 installed on a substrate 130. Reference number 530 collectively refers to the low-tack adhesive layer, the substrate sheet layer 510, and the second adhesive layer 520. Accordingly, such embodiments may be purchased by a user as a unit and applied to a container of his or her choice. In some embodiments, the second adhesive layer 520 may be a reusable pressure sensitive adhesive and may be either high or low tack. In other embodiments the second adhesive layer 520 may be solvent or water activated. FIG. 6 shows the embodiment 500 in a free-standing uninstalled configuration 600. One skilled in the art will recognize that embodiments such as the one shown here may include a release film, or the embodiments may be adapted to adhere stack-wise to each other.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

Having thus described the invention, it is now claimed:

I/We claim:

1. A self-erasing memorandum system, comprising:
a low-tack adhesive layer adapted to be adhered to a substrate, the low-tack adhesive layer defining a predetermined two-dimensional shape and area; and
a polymer film adapted to contact and substantially cover the low-tack adhesive layer, wherein the polymer film is adapted to reversibly adhere to the low-tack adhesive layer while maintaining a translucent layer of air therebetween, wherein the polymer film and low-tack adhesive layer are adapted to displace at least a portion of the translucent air layer in response to pressure applied to selected portions of the polymer film.

2. The system of claim 1, wherein the low-tack adhesive layer comprises a reusable low-tack pressure sensitive composition.

3. The system of claim 1, wherein the low-tack adhesive layer defines a thickness between about 0.01 to about 0.1 mils, 0.1 to 0.5 mils, 0.5 to 1 mils, 1 to 5 mils, 5 to 10 mils, 10 to 50 mils, 50 to 100 mils, or any combination thereof.

4. The system of claim 1, wherein the substrate comprises ceramic, glass, metal, or plastic.

5. The system of claim 1, wherein the substrate comprises one or more of a container, a food container, a beverage container, container labeling, or container packaging.

6. The system of claim 1, wherein the polymer film is colorless, pigmented, translucent, transparent, partially transparent, or any combination thereof.

7. The system of claim 6, wherein the polymer film comprises one or more of polycarbonate, polymethylmethacrylate, acrylic polymer, polyester, cellulose, cellophane, polyolefin, polyethylene, polypropylene, polyethyleneterephthalate, polyvinyl chloride, or any combination thereof.

8. The system of claim 7, wherein the polymer film defines a thickness from about 0.1 to 0.5 mils, 0.5 to 1 mils, 1 to 5 mils, 5 to 10 mils, 10 to 50 mils, or even 50 to 100 mils.

9. The system of claim 1, wherein the polymer film is adapted to be permanently affixed to the substrate at one edge of the polymer film forming a flap adapted to adhere to and be separated from the adhesive layer while remaining attached to the substrate.

10. The system of claim 1, wherein the substrate comprises a free-standing monolithic structure which defines a substrate sheet, and which is adapted to be adhesively affixed to a second substrate.

11. The system of claim 10, wherein the substrate sheet supports the low-tack adhesive layer on one face of the substrate sheet, and the substrate sheet supports a second adhesive layer on a second face of the substrate sheet.

12. A self-erasing memorandum system, comprising:
a substrate sheet having a first face and a second face generally opposing the first face;
a low-tack adhesive layer disposed on the first face of the substrate sheet, the low-tack adhesive layer defining a predetermined two-dimensional shape and area;
a second adhesive layer disposed on the second face of the substrate sheet; and
a polymer film adapted to contact and substantially cover the low-tack adhesive layer, wherein the polymer film is adapted to reversibly adhere to the low-tack adhesive layer while maintaining a translucent layer of air bubbles therebetween, wherein the polymer film and low-tack adhesive layer are adapted to displace at least a portion of the translucent air bubble layer in response to pressure applied to selected portions of the polymer film.

13. A container, comprising:
a wall structure at least partially inclosing a space for containing an arbitrary substance, the wall structure having and inner surface and an outer surface, wherein the outer surface defines a substrate;
a low-tack adhesive layer disposed on and at least partially covering the substrate, the adhesive layer defining a predetermined two-dimensional shape and area; and
a polymer film adapted to contact and substantially cover the low-tack adhesive layer, wherein the polymer film is adapted to reversibly adhere to the low-tack adhesive layer while maintaining a translucent layer of air bubbles therebetween, wherein the polymer film and low-tack adhesive layer are adapted to displace at least a portion of the translucent air bubble layer in response to pressure applied to selected portions of the polymer film.

14. The container of claim 13, wherein the polymer film is permanently affixed to the substrate at one edge of the polymer film forming a flap adapted to adhere to and be separated from the adhesive layer while remaining attached to the substrate.
